(19) United States
(12) Patent Application Publication
(10) Pub. No.: US 2024/0089045 A1
(43) Pub. Date: Mar. 14, 2024

(54) COMMUNICATION SYSTEM, COMMUNICATION APPARATUS, METHOD FOR CONTROLLING COMMUNICATION APPARATUS, AND STORAGE MEDIUM

(71) Applicant: CANON KABUSHIKI KAISHA, Tokyo (JP)

(72) Inventor: TOMOYUKI TAKADA, Tokyo (JP)

(21) Appl. No.: 18/461,017

(22) Filed: Sep. 5, 2023

(30) Foreign Application Priority Data
Sep. 8, 2022 (JP) 2022-143291

(51) Int. Cl. H04L 5/00; H04W 72/0453

(52) U.S. Cl. CPC H04L 5/0046; H04L 5/0048; H04W 72/0453

(57) ABSTRACT

A communication system including a first communication apparatus and a second communication apparatus, wherein the first communication apparatus receive from the second communication apparatus, information indicating a bandwidth to be used by the second communication apparatus to communicate with the first communication apparatus, transmitting, in transmitting a downlink Multi-User Physical Layer Protocol Data Unit (MU PPDU) to a plurality of communication apparatuses including the second communication apparatus with a predetermined bandwidth in a case where the bandwidth to be used by the second communication apparatus indicated by the received information is smaller than the predetermined bandwidth, an MU PPDU in which a subcarrier at the end of a frequency domain is not modulated with demodulation target data but a subcarrier different from the subcarrier at the end is modulated with demodulation target data, from among subcarriers that are to store data to be transmitted to the second communication apparatus.

### BACKGROUND

### Field

The present disclosure relates to a communication system performing wireless communication, a communication apparatus, a method for controlling the communication apparatus, and a program.

### Description of the Related Art

With the increase in the amount of communication data in recent years, communication techniques such as wireless Local Area Network (LANs) are being developed. The Institute of Electrical and Electronic Engineers (IEEE) 802.11 standard series provides major communication standards for wireless LANs. The IEEE 802.11 standard series includes the IEEE 802.11a/b/g/n/ac/ax standards. For example, IEEE 802.11ax as the latest standard standardizes a technique for improving the transmission rate under a congestion state by using Orthogonal Frequency Division Multiple Access (OFDMA) in addition to a throughput of up to 9.6 gigabits/s (Gbps) (see Re-publication of 2012/008097).

The IEEE 802.11be (EHT) standard is under development; it will be a successor standard aiming for the further improvement of the throughput, frequency usage efficiency, and communication latency.

Also, a mechanism for enabling a station (STA) operating with the 80 MHz channel width to receive wireless frames having a channel width larger than 80 MHz is currently being studied.

More specifically, a technique for enabling the STA operating with the 80 MHz channel width to also receive an Extremely High Throughput Multi-User Physical Layer Protocol Data Unit (EHT MU PPDU) with 160 and 320 MHz channel widths is currently being studied (see IEEE 802.11-21/1943r0 Issue of large BW support, Dec. 1, 2021, [Searched in Aug. 29, 2022], Internet (https://mentor.ieee.org/802.11/dcn/21/11-21-1943-00-00be-issue-of-large-bw-support.pptx)). Also, according to the same document, a technique for enabling an STA operating with a channel width of 160 MHz or less to also receive an EHT MU PPDU with the 320 MHz channel width in addition to an EHT MU PPDU with a channel width smaller than 160 MHz is currently being studied.

Generally, when a certain terminal receives a signal with a channel width larger than its own operating channel width, the terminal first performs filtering processing. In the filtering processing, the terminal extracts a signal in the operating channel by attenuating signals outside the operating channel from a received signal. Then, the terminal generates a signal sampled at a sampling frequency equal to the operating channel width, and then demodulates the signal. This enables reducing the circuit scale and power consumption required for the demodulation in comparison with a case where the signal is sampled at a sampling frequency higher than the channel width of the received signal.

For example, in a case where an STA operating with the 80 MHz operating channel width receives a signal with the 160 MHz channel width, the terminal extracts a signal with the 80 MHz channel width from the received signal, samples the signal at the 80 MHz sampling frequency, and then demodulates the signal.

In the above-described filtering processing, it is more difficult to attenuate signals outside the operating channel when signals outside the operating channel are closer to the operating channel. On the other hand, according to the IEEE 802.11be standard, the interval between a signal in the frequency domain to be assigned to the terminal and a signal in the frequency domain to be assigned to another terminal may be smaller than 2 MHz when performing OFDMA-based downlink multi-user transmission. This interval is not sufficient to sufficiently attenuate the signal assigned to another terminal. As a result, signals outside the operating channel becomes aliasing noise during sampling and is superimposed on the signal in the operating channel, i.e., aliasing occurs. Aliasing largely affects the subcarrier at the end of the frequency domain assigned to the terminal, degrading the Carrier Noise Ratio (CNR) of the subcarrier at the end of the frequency domain assigned to the terminal. As a result, there is a concern about the increase in the frame error rate when an attempt is made to simply receive the PPDU with a bandwidth larger than the operating channel width of the terminal and then subject the PPDU to down-sampling to demodulate the PPDU.

### SUMMARY

Various embodiments of the present disclosure have been embodied in view of at least one of the above-described issues. Some embodiments of the present disclosure are directed to preventing the degradation of the communication efficiency when performing signal reception involving filtering processing and down-sampling processing.

According to one embodiment of the present disclosure, a communication system including at least a first communication apparatus and a second communication apparatus is provided. The first communication apparatus includes at least one memory that stores a set of instructions, and at least one processing circuit, where the first communication apparatus is caused, by the at least one processing circuit executing the instructions and/or the at least one processing circuit itself operating, to perform operations including receiving, from the second communication apparatus, information indicating a bandwidth to be used by the second communication apparatus to communicate with the first communication apparatus, transmitting, in transmitting a downlink Multi-User Physical Layer Protocol Data Unit (MU PPDU) to a plurality of communication apparatuses including at least the second communication apparatus with a predetermined bandwidth in a case where the bandwidth to be used by the second communication apparatus indicated by the received information is smaller than the predetermined bandwidth, an MU PPDU in which a subcarrier at the end of a frequency domain is not modulated with demodulation target data but a subcarrier different from the subcarrier at the end is modulated with demodulation target data, from among subcarriers that are to store data to be transmitted to the second communication apparatus. The second communication apparatus includes at least one memory that stores a set of instructions, and at least one processing circuit, where the second communication apparatus is caused, by the at least one processing circuit executing the instructions and/or the at least one processing circuit itself operating, to perform operations including demodulating, in a case where the MU PPDU with the predetermined bandwidth larger than the bandwidth to be used is received, the MU PPDU, assuming that the data that is modulating a subcarrier configuring the frequency domain different from the subcarrier at the end, is demodulation target data.

Further features of the present disclosure will become apparent from the following description of exemplary embodiments with reference to the attached drawings.

### BRIEF DESCRIPTION OF THE DRAWINGS

FIG. 1 illustrates an example of a communication system.

FIG. 2 illustrates an example hardware configuration of a communication apparatus.

FIG. 3 illustrates an example functional configuration of the communication apparatus.

FIG. 4 illustrate an example of control performed by an access point.

FIGS. 5A and 5B are charts illustrating a subcarrier with a 160 MHz bandwidth.

FIGS. 6A to 6D are charts illustrating a subcarrier with a 320 MHz bandwidth.

FIG. 7 illustrates an example of control performed by a station.

FIG. 8 illustrates an example of information communicated between apparatuses.

FIG. 9 illustrates another example of information communicated between apparatuses.

FIG. 10 illustrates still another example of information communicated between apparatuses.

### DESCRIPTION OF THE EMBODIMENTS

Exemplary embodiments of the present disclosure will be described below with reference to the accompanying drawings. The following exemplary embodiments do not limit the scope of the present invention specified in the appended claims. Not all of the combinations of the features described in the present exemplary embodiment are indispensable to the solutions for the present disclosure.

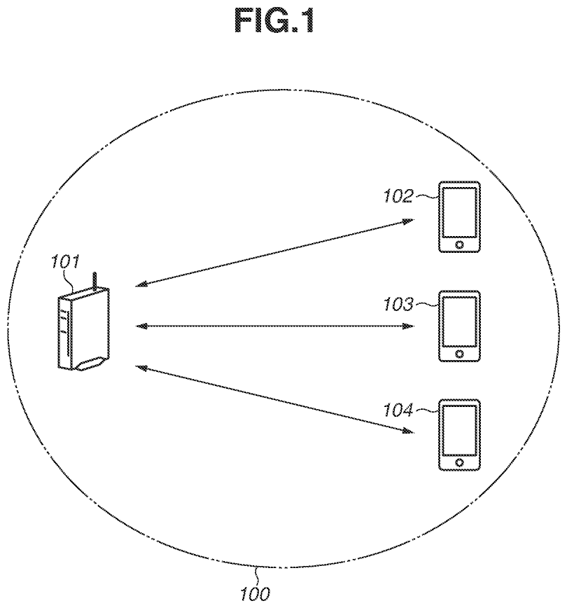

A communication system 100 according to the present exemplary embodiment will be described below with reference to FIG. 1. The communication system 100 according to the present exemplary embodiment includes communication apparatuses 101 to 104. The communication apparatus 101 as a first communication apparatus is an Extremely High Throughput Access Point Station (EHT AP STA) conforming to the IEEE 802.11be standard. Hereinafter, the communication apparatus 101 is also simply referred to as an access point 101 or an AP 101. The communication apparatuses 102 to 104 as second communication apparatuses are non-AP EHT STAs conforming to the IEEE 802.11be standard. The communication apparatuses 102 to 104 are also simply referred to as stations 102 to 104 or STAs 102 to 104.

The AP 101 and the STAs 102 to 104 are capable of performing wireless communication conforming to the IEEE 802.11be standard.

The communication apparatuses 101 to 104 can communicate with each other in the 2.4, 5, and 6 GHz bands. The AP 101 can operate with 20, 40, 80, 160, and 320 MHz channel widths. The STAs 102 to 104 can also operate with the same channel widths. In the following descriptions, at least one of the STAs 102 to 104 operates with the 80 MHz channel width.

The communication apparatuses 101 to 104 are capable of performing Multi-User (MU) communication by using the Orthogonal Frequency Division Multiple Access (OFDMA) technique. The communication apparatuses 101 to 104 can perform MU communication by using the Multi-User Multi-Input Multi-Output (MU-MIMO) technique.

More specifically, the AP 101 and a plurality of STAs from among the STAs 102 to 104 can communicate simultaneously with each other through one channel (including a channel with a combined channel width of 40 MHz or larger). In simultaneous communication using the OFDMA technique, one channel is divided into a plurality of subchannels called Resource Units (RUs). Then, assigning each of the divided RUs to different STAs (or an STA group including a plurality of STAs) enables the AP 101 and a plurality of STAs to simultaneously communicate with each other through one channel. The MU-MIMO technique forms a plurality of spatial streams by using a plurality of antennas and assigns the spatial streams to different STAs to implement spatial multiplexing for enabling the AP and a plurality of STAs to simultaneously communicate with each other through one channel.

The communication apparatuses 101 to 104 perform wireless communication conforming to the IEEE 802.11be standard. In addition, the communication apparatuses 101 and 104 may be configured to perform wireless communication conforming to the IEEE 802.11 standard earlier than the IEEE 802.11be standard. More specifically, the communication apparatuses 101 to 104 may support at least one of the IEEE 802.11a/b/g/n/ac/ax standards.

The communication apparatuses 101 to 104 may support the IEEE 802.11 standard later than the IEEE 802.11be standard. More specifically, the communication apparatuses 101 to 104 may support the successor standard of the IEEE 802.11be standard currently being studied by Ultra High Reliability (UHR) Study Group. The successor standard aims for the maximum transmission rate of 90 to 100 Gbps. In this case, Ultra High Reliability (UHR) Multi-User (MU) PPDU is transmitted instead of the EHT MU PPDU (described below).

Each communication apparatus may support other communication specifications such as Bluetooth (registered trademark), Near Field Communication (NFC), Ultra Wide Band (UWB), ZigBee, and Multi Band OFDM Alliance (MBOA) in addition to the IEEE 802.11 standard series. UWB includes wireless Universal Serial Bus (USB), Wireless 1394, and WiNET. Each communication apparatus may support wired communication specifications such as a wired LAN.

Specific examples of the AP 101 include a wireless LAN router and a Personal Computer (PC), but the present invention is not limited thereto. The AP 101 may be an information processing apparatus such as a wireless chip set capable of performing wireless communication conforming to the IEEE 802.11be standard.

Specific examples of the STAs 102 to 104 include cameras, tablet computers, smart phones, PCs, portable telephones, video cameras, head sets, and wearable devices, but the present invention is not limited thereto. The STAs 102 to 104 may also be printers and scanners. The STAs 102 to 104 and the AP 101 may be information processing apparatuses such as wireless chip sets capable of performing wireless communication conforming to the IEEE 802.11be standard.

Although the wireless system in FIG. 1 includes one AP and three different STAs as an example, the numbers of APs and STAs are not limited thereto.

### <Hardware Configuration of Communication Apparatus>

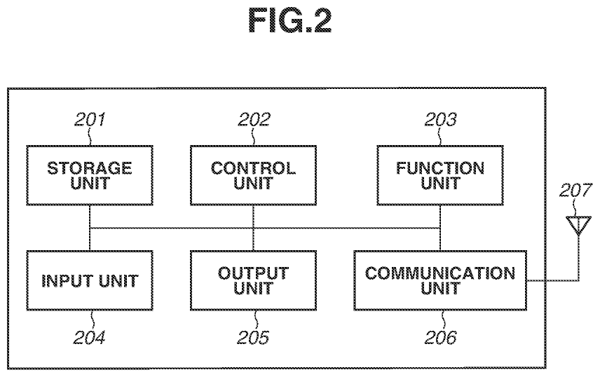

FIG. 2 illustrates an example hardware configuration of the AP 101 according to the present exemplary embodiment. The AP 101 includes a storage unit 201, a control unit 202, a function unit 203, an input unit 204, an output unit 205, a communication unit 206 and an antenna 207. The AP 101 may include a plurality of antennas.

The storage unit 201 includes one or more memories such as a Read Only Memory (ROM) and a Random Access Memory (RAM). The storage unit 201 stores computer programs for performing various operations (described below) and various information such as communication parameters for wireless communication. The storage unit 201 may also include a hard disk, a nonvolatile memory, and other storage media may be used in addition to the memories such as the ROM and the RAM. The storage unit 201 may also include a plurality of memories.

The control unit 202 includes one or more processors such as a Central Processing Unit (CPU) and a Micro Processing Unit (MPU), and controls the entire AP 101 by executing computer programs stored in the RAM, which is the storage unit 201. The control unit 202 may control the entire AP 101 through the collaboration between the computer programs stored in the storage unit 201 and an Operating System (OS). The control unit 202 generates data and signals (wireless frames) to be transmitted in communication with other communication apparatuses. The control unit 202 demodulates data and signals (wireless frames) received from other communication apparatuses. The control unit 202 may include a plurality of processors such as multi-core processors and control the entire AP 101 by using the plurality of processors.

Processing in flowcharts performed by the control unit 202 (described below) can be implemented by using a hardware circuit such as an Application Specific Integrated Circuit (ASIC) or a Field Programmable Gate Array (FPGA). Processing in flowcharts (described below) can be implemented through the collaboration between the hardware circuit and the processor such as the CPU and MPU.

The control unit 202 controls the function unit 203 to perform predetermined processing such as wireless communication, imaging, printing, and projection. The function unit 203 is a hardware component necessary for the AP 101 to perform predetermined processing. For example, in a case where the communication apparatus is a camera, the function unit 203 serves as an imaging unit that performs imaging processing. In a case where the apparatus is a printer, the function unit 203 serves as a printing unit that performs print processing for printing an image based on received print data, for example, on a paper sheet. For example, in a case where the apparatus is a projector, the function unit 203 serves as a projection unit that performs projection processing for projecting a projection image based on received image and moving image data on a projection plane. In a case where the apparatus is a scanner, for example, the function unit 203 serves as a reading unit such as a sensor that reads a paper document to generate image data and performs transmission processing for transmitting the image data to the outside. In a case where the apparatus is a wearable device such as a head mount display, the function unit 203 performs projection processing for projecting an image based on data received from the outside on a projection plane such as the retina. Further, in the case where the apparatus is a head mount display, the function unit 203 also performs transmission processing for transmitting information acquired by a device to an external cooperative apparatus. For example, the function unit 203 performs transmission processing for transmitting information and data obtained from a sensor embedded in a device and a camera for capturing peripheral images, and user input information obtained from a human interface device such as a game controller (not illustrated) to the outside.

Data processed by the function unit 203 may include data stored in the storage unit 201 and data received from communication apparatuses such as other APs and STAs via the communication unit 206 (described below). Data generated by the processing of the function unit 203 can be transmitted to external apparatuses such as other STAs and APs.

The input unit 204 receives various operations from the user. The output unit 205 outputs various types of data via a monitor screen and a speaker to the user. Outputs by the output unit 205 may include display on the monitor screen, an audio output to the speaker, and a vibratory output. The input unit 204 and the output unit 205 may be implemented as a single module like a touch panel. Each of the input unit 204 and the output unit 205 may also be integrated with the AP 101 or provided separately therefrom.

The communication unit 206 controls wireless communication conforming to the IEEE 802.11be standard. The communication unit 206 may also control wireless communication conforming to other IEEE 802.11 series standards in addition to the IEEE 802.11be standard, and control wired communication such as a wired LAN. The communication unit 206 controls the antenna 207 to transmit and receive wireless communication signals generated by the control unit 202.

In a case where the AP 101 supports the NFC or Bluetooth standard in addition to the IEEE 802.11be standard, the communication unit 206 may control wireless communication conforming to these communication standards. If the AP 101 can perform wireless communication conforming to a plurality of communication standards, the AP 101 may include communication units and antennas conforming to the different communication standards. The AP 101 communicates image data, document data, and video data with the STAs 102 to 104 via the communication unit 206. The antenna 207 may be configured as a separate unit of the communication unit 206 or integrated with the communication unit 206 as one module.

The antenna 207 is capable of performing communication in the 2.4, 5, and 6 GHz bands. The AP 101 may be provided with one or a plurality of antennas, or different antennas for different frequency bands. If the AP 101 is provided with a plurality of antennas, the AP 101 may include the communication unit 206 supporting each antenna.

Hardware configurations of the STAs 102 to 104 are similar to the hardware configuration of the AP 101, and redundant descriptions thereof will be omitted.

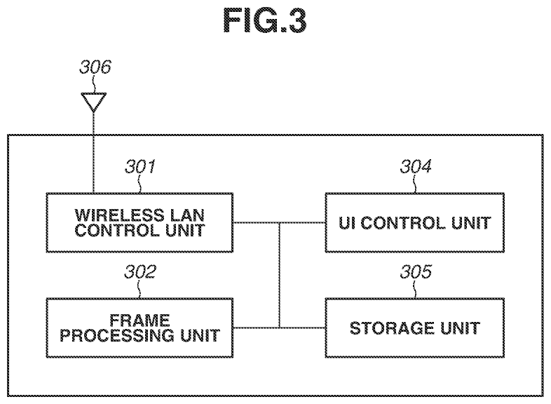

FIG. 3 is a block diagram illustrating the functional configuration of the AP 101 and the STAs 102 to 104 according to the present exemplary embodiment. The STAs 102 to 104 are configured in a similar way. The AP 101 includes a wireless LAN control unit 301. The AP 101 may include one or a plurality of wireless LAN control units. The AP 101 further includes a frame processing unit 302, a User Interface (UI) control unit 304, a storage unit 305, and a wireless antenna 306.

The wireless LAN control unit 301 includes an antenna and a circuit for transmitting and receiving wireless signals to/from other wireless LAN apparatuses, and programs for controlling the antenna and the circuit. The wireless LAN control unit 301 controls wireless LAN communication based on frames generated by the frame processing unit 302 according to the IEEE 802.11 standard series.

The frame processing unit 302 processes wireless control frames transmitted and received by the wireless LAN control unit 301. The content of wireless control generated and analyzed by the frame processing unit 302 may be restricted based on settings stored in the storage unit 305 or changed by user settings from the UI control unit 304. Generated frame information is transmitted to the wireless LAN control unit 301 and then transmitted to the communication partner. Frame information received by the wireless LAN control unit 301 is transferred to the frame processing unit 302 and then analyzed.

The UI control unit 304 includes hardware components related to a user interface such as a touch panel and buttons (not illustrated) for receiving user operations for the STAs 102 to 104 performed on the AP 101, and programs for controlling these hardware components. The UI control unit 304 is also provided with a function of displaying images or a function of presenting audio output information to the user.

The storage unit 305 manages operation settings and operation parameters of the AP 101 stored in the storage unit 201 (ROM and RAM). The UI control unit 304 requests the storage unit 305 to change the settings upon reception of a user operation for changing settings. The storage unit 305 updates the operation settings and operation parameters to be stored in the storage unit 201 based on the request. The storage unit 305 also manages information about the communication partner the AP 101 communicates with. The frame processing unit 302 and each control unit perform processing in flowcharts (described below) by suitably referencing the parameters managed by the storage unit 305.

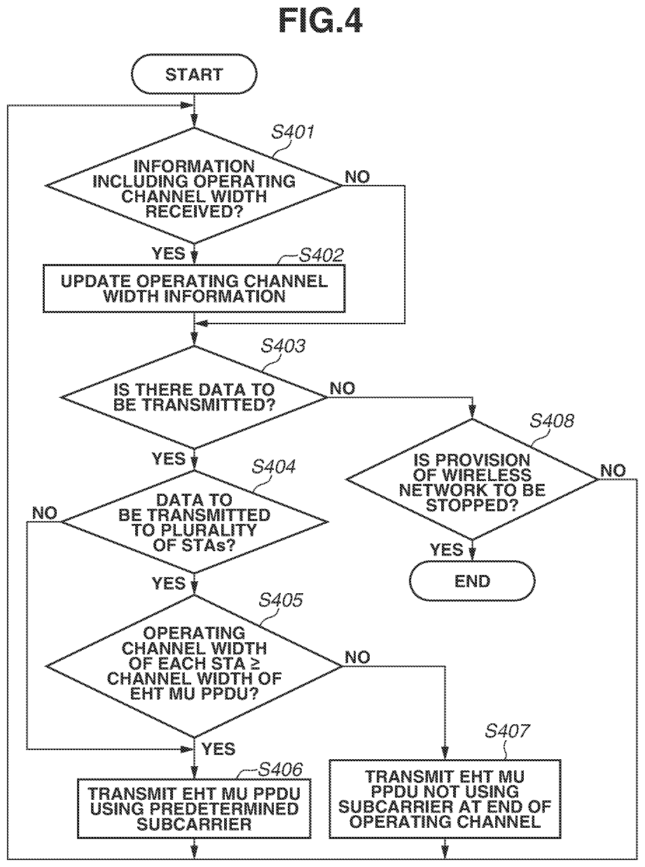

The operation of the AP 101 related to the transmission of the EHT MU PPDU for downlink multi-user communication will be described below with reference to FIG. 4. This operation is performed when the AP 101 starts the provision of a wireless network conforming to the IEEE 802.11be standard, i.e., the network of a group identified by a Basic Service Set (BSS).

The start of the provision will be described below. The AP 101 starts the provision of a wireless network identified by the BSS based on an instruction input by the user. Examples of relevant instructions include an instruction by pressing a hardware key such as a power button and an instruction by pressing an operation start button displayed on the touch panel. Upon reception of the relevant instruction, the AP 101 starts transmitting a Beacon frame conforming to the IEEE 802.11be standard. The operation of the AP 101 illustrated in FIG. 4 is implemented by the control unit 202 hardware-wise and implemented by the frame processing unit 302 functionality-wise. The following descriptions will be made on the premise that the operation is performed by the control unit 202.

In step S401, the control unit 202 determines whether the AP 101 has received information including the operating channel width from an STA. Information about the operating channel width is indicated by the value of the Supported Channel Width Set subfield of the HE Capabilities element. Alternatively, the information is indicated as a combination of this value and the value of the Supported For 320 MHz In 6 GHz subfield of the EHT Capabilities element. The information about the operating channel width is indicated as a combination of the value of the Supported Channel Width Set subfield of the HT Capabilities or the VHT Capabilities element and the value of the extension field. In this case, the extension field used for the combination is the Extended NSS BW Support subfield.

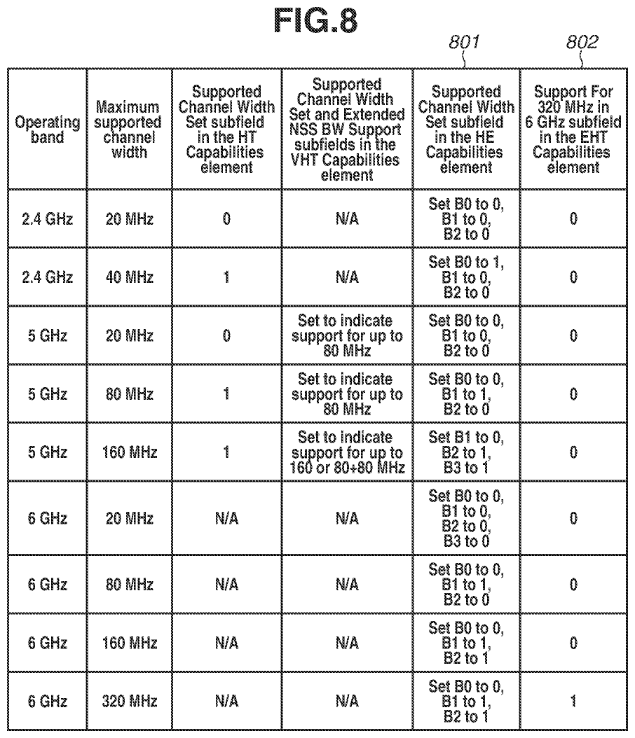

The relation between the operating channel width and the values of these subfields will be described below with reference to FIG. 8.

B1 to B3 in an element 801 in FIG. 8 indicate bit positions in the subfields. The value 1 of B1 indicates that the 80 MHz channel width is supported, and the value 0 of B1 indicates that the 80 MHz channel width is not supported. The value 1 of B2 indicates that the 160 MHz channel width is supported, and the value 0 of B2 indicates that the 160 MHz channel width is not supported. The value of B3 indicates whether the 80+80 MHz channel is supported.

The value 1 in an element 802 indicates that the 320 MHz channel width is supported, and the value 0 in the element 802 indicates that the 320 MHz channel width is not supported. The operating channel width identified based on these pieces of information indicates the maximum bandwidth that can be used by an STA to communicate with the AP 101.

These elements are included in the Probe Request or the Association Request frame transmitted from the STA to the AP 101. The STA transmits these frames to the AP 101 to find the AP 101 or participate in the network identified by the BSS.

When the control unit 202 receives the Association Request frame from an STA, the control unit 202 transmits the Association Response as a response to the request to the STA, to permit it to participate in the BSS. When the control unit 202 receives the Probe Request from an STA, the control unit 202 transmits the Probe Response frame as a response to the request to the STA.

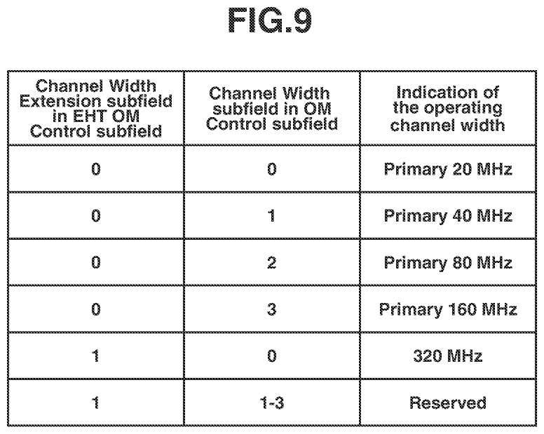

The operating channel width may be identified based on the value of the Channel Width subfield of the OM control subfield. Alternatively, the operating channel width may be identified based on the value of the Channel Width Extension subfield of the EHT OM Control subfield. An example relation between the operating channel width and the values of these subfields is illustrated in FIG. 9. These elements are carried with the QoS Data, QoS Null, or Class 3 Management frame used in the operation mode indication (OMI) procedure specified in the IEEE 802.11be standard. These frames are transmitted when an STA changes the operation mode i.e., the channel width or the number of spatial streams after participating in the BSS.

In a case where the control unit 202 determines that information including the operating channel width is newly received (YES in step S401), the processing proceeds to step S402. On the other hand, in a case where the control unit 202 does not determine that information including the operating channel width is newly received (NO in step S401), the processing proceeds to step S403.

In step S402, the control unit 202 updates the operating channel width information for the STA stored and managed by the AP 101, based on the information including the operating channel width received in step S401. This processing allows the control unit 202 to store and manage the current operating channel width for each STA.

In step S403, the control unit 202 determines whether there is data to be transmitted to one or more STAs. In a case where the control unit 202 determines that there is data to be transmitted to one or more STAs (YES in step S403), the processing proceeds to step S404. On the other hand, in a case where the control unit 202 determines that there is no data to be transmitted to one or more STAs (NO in step S403), the processing proceeds to step S408.

In step S404, the control unit 202 determines whether the data to be transmitted includes data to be separately transmitted to each individual STA (or each individual STA group including a plurality of STAs). In a case where the control unit 202 determines that the data to be transmitted includes such data (YES in step S404), the processing proceeds to step S405. On the other hand, in a case where the control unit 202 determines that the data to be transmitted does not include such data (NO in step S404), the processing proceeds to step S406.

In step S405, the control unit 202 determines whether the operating channel widths of all of the STAs that are data transmission destinations are equal to or larger than the channel width of the EHT MU PPDU to be transmitted by the AP 101. In a case where the control unit 202 determines that the operating channel widths of all of the STAs that are data transmission destinations are equal to or larger than the channel width of the EHT MU PPDU (YES in step S405), the processing proceeds to step S406. On the other hand, in a case where the control unit 202 determines that the operating channel widths of all of the STAs that are data transmission destinations are not equal to or larger than the channel width of the EHT MU PPDU (NO in step S405), the processing proceeds to step S407. In other words, in a case where the operating channel width of at least one STA is smaller than the channel width to be used for the transmission of the EHT MU PPDU, the processing proceeds to step S407.

The channel width of the EHT MU PPDU (predetermined bandwidth to be used for the transmission of the EHT MU PPDU) may be determined based on an instruction input by the user or on the operating channel widths of the STAs. For example, the control unit 202 may set the channel width to the maximum value of the operating channel widths of a plurality of STAs participating in the BSS. The control unit 202 may also set the channel width to a channel width that reduces the influence of electric wave noise around the AP 101.

In step S406, the control unit 202 generates an EHT MU PPDU with the predetermined bandwidth, i.e., an EHT MU PPDU for carrying data by using a predetermined subcarrier, and then transmits the EHT MU PPDU. In a case where the control unit 202 determines that the data to be transmitted includes the relevant data (YES in step S404), the downlink MU PPDU toward a plurality of STAs will be transmitted.

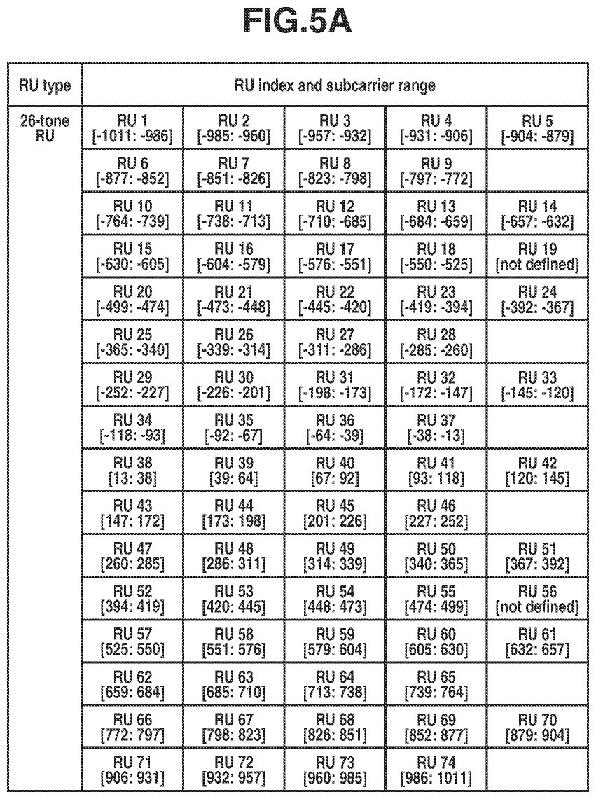

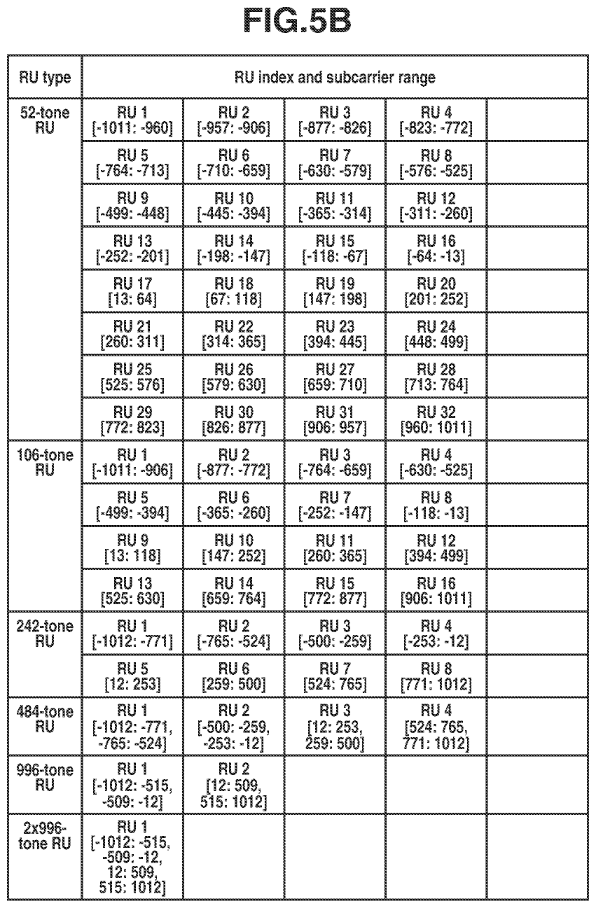

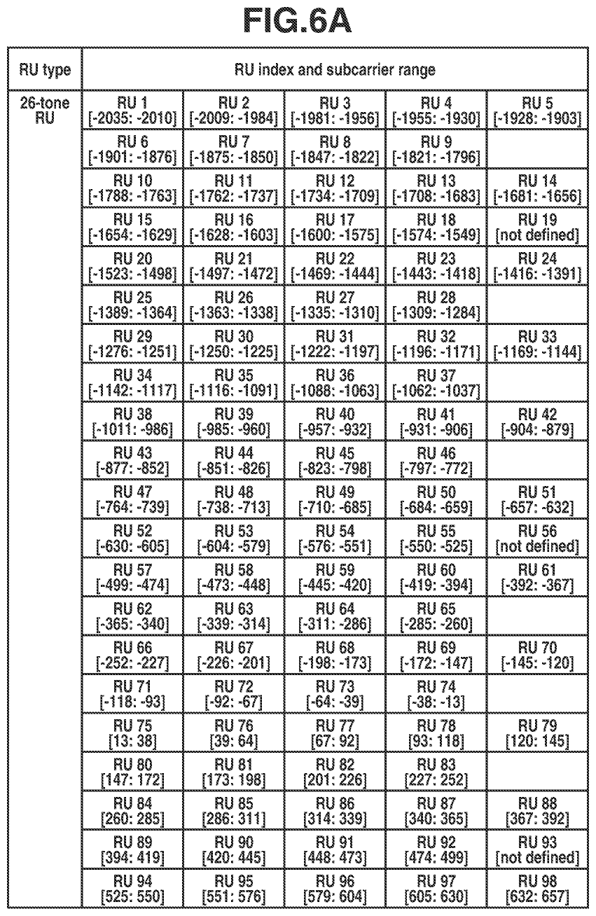

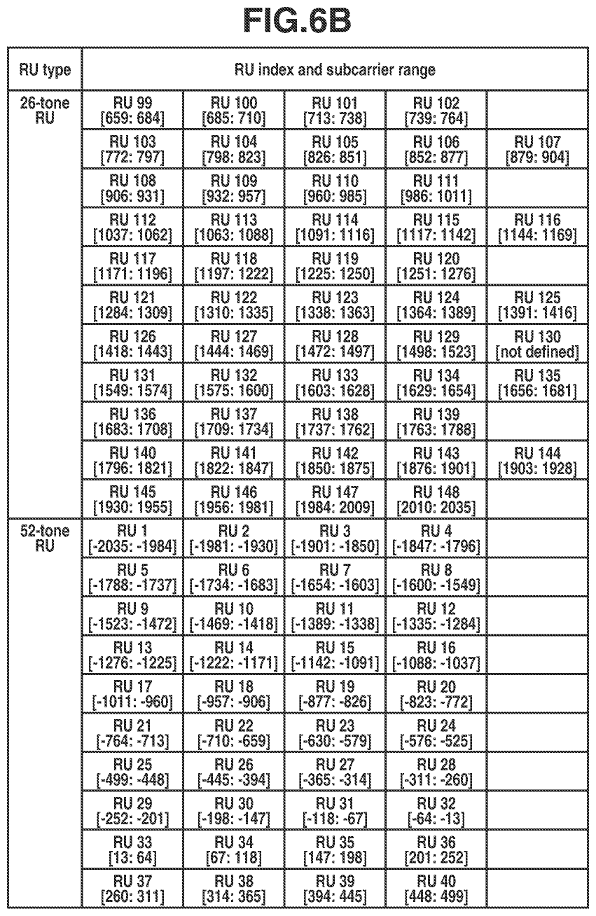

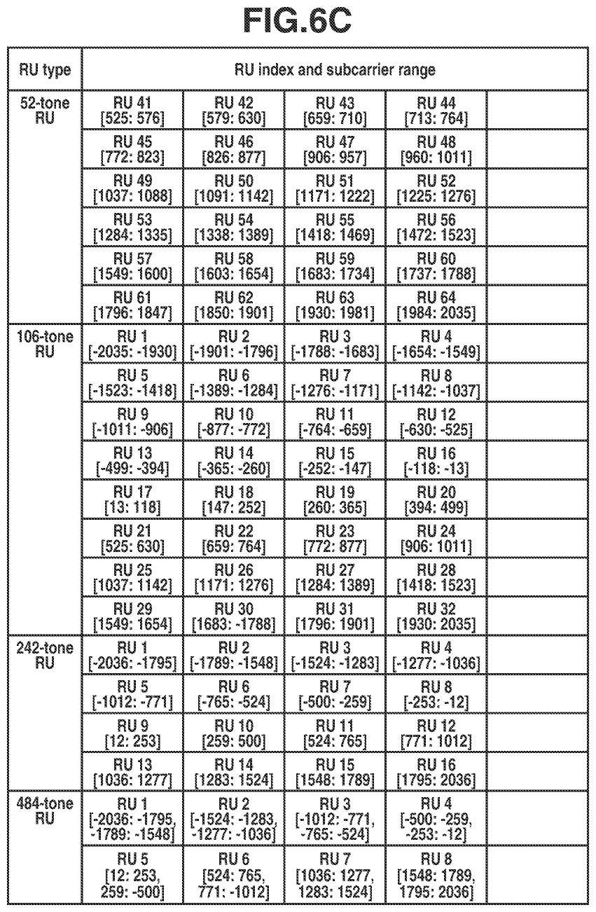

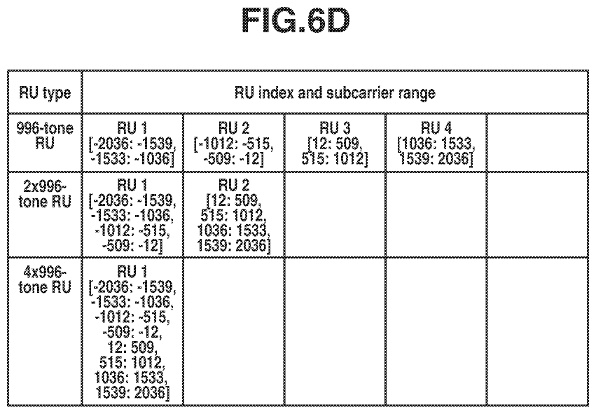

Subcarriers will be described below with reference to FIGS. 5 and 6. FIG. 5 illustrates examples of subcarriers to be used in a case where the channel width for the transmission of the EHT MU PPDU is 160 MHz. The subcarrier to be used depends on the RU type and RU index to be used in the channel for the transmission of the EHT MU PPDU. The RU type is determined by the number of subcarriers included in the RU type. For example, the 996-tone RU includes 996 subcarriers. FIG. 5 illustrates, for each RU type, RU indices of RUs configuring channels, and the subcarrier index of the subcarrier to be used in the RU for each RU index. The subcarrier index is 0 at the center of the channel, and the absolute value increases with decreasing distance to the outside of the channel, i.e., an end of the channel. For example, the RU of the RU index 1 of the RU type 996-tone RU uses 996 subcarriers (subcarrier indices −1012 to −515 and −509 to −12). Subcarriers of the subcarrier indices indicated herein carry not only data but also a pilot symbol for performing equivalent processing with a communication apparatus that receives the EHT MU PPDU.

FIG. 6 illustrates examples of subcarriers to be used in a case where the channel width for the transmission of the EHT MU PPDU is 320 MHz. The view of FIG. 6 is similar to that in FIG. 5.

The control unit 202 assigns the RUs illustrated in FIGS. 5 and 6 to each terminal based on the data amount to be transmitted to each apparatus and the data access category. Information about the RU assignment to each terminal is stored in the RU Allocation Subfield of the EHT-SIG field or the user field as a part of the preamble of the EHT MU PPDU.

The data field stores data destined to different STAs multiplexed in the frequency domain.

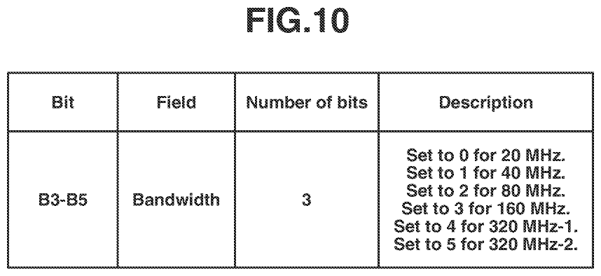

Information indicating the channel width of the EHT MU PPDU is stored in the Bandwidth (BW) Field of the Universal Signal (U-SIG) field as a part of the preamble. FIG. 10 illustrates the values of the BW field stored in the U-SIG field. The control unit 202 stores the value corresponding to the channel width of the EHT MU PPDU in the BW field. For example, the control unit 202 stores “3” for 160 MHz and stores “4” or “5” for 320 MHz.

In step S407, the control unit 202 generates an EHT MU PPDU in which the subcarrier at the end of the operating channel is not used for data or pilot signal transmission with respect to STAs the operating channel width of which is smaller than the channel width of the EHT MU PPDU. The band width of the EHT MU PPDU generated and transmitted by the control unit 202 in step S407 is also the above-described predetermined bandwidth. Not using the subcarrier at the end of the operating channel for data or pilot signal transmission means not modulating the relevant subcarrier with significant data (data to be subjected to decoding) or a pilot signal. In other words, the subcarrier at the end of the operating channel may be a null subcarrier, i.e., a subcarrier with zero amplitude, or may store a random dummy value. In a case where the control unit 202 determines that there is data to be transmitted to a plurality of STAs (YES in step S404), the downlink MU PPDU toward the plurality of STAs will be transmitted.

The operating channel with the 80 MHz channel width can be positioned at RU1 or RU2 of the 996-tone RU in FIG. 5 in the EHT MU PPDU with the 160 MHz channel width. The operating channel with the 80 MHz channel width can be positioned at one of RU1 to RU4 of the 996-tone RU in FIG. 6 in the EHT MU PPDU with the 320 MHz channel width. The operating channel with the 160 MHz channel width can be positioned at RU1 or RU2 of the 2×996-tone RU in FIG. 6 in the EHT MU PPDU with the 320 MHz channel width.

Therefore, for example, in a case where the bandwidth of the entire PPDU is 160 MHz and an STA1 is using 80 MHz on the low frequency side as the operating channel, the control unit 202 controls the STA1 not to use the subcarrier positioned at the end of the assigned RU1 for data transmission. The control unit 202 controls the STA1 not to use the subcarriers of indices −1012 to (−1012+n) and (−12−m) to −12 positioned at the end of the RU1 of the 996-tone RU illustrated in FIG. 5 for data or pilot signal transmission. In other words, the control unit 202 does not modulate the subcarrier at the end with significant data or a pilot signal. n and m are integers equal to or larger than 0.

Likewise, in a case where the channel width of the EHT MU PPDU is 160 MHz and an STA is using 80 MHz on the high frequency side as the operating channel, the control unit 202 controls the STA not to use the subcarrier positioned at the end of the RU2 of the 996-tone RU illustrated in FIG. 5 for data or pilot signal transmission. In a case where the channel width of the EHT MU PPDU is 320 MHz and an STA is using the lowest 80 MHz channel as the operating channel, the control unit 202 controls the STA not to use the subcarrier positioned at the end of the RU1 of the 996-tone RU illustrated in FIG. 6 for data or pilot signal transmission. In a case where the channel width of the EHT MU PPDU is 320 MHz and an STA is using the second lowest 80 MHz channel as the operating channel, the control unit 202 controls the STA not to use the subcarrier positioned at the end of the RU2 of the 996-tone RU illustrated in FIG. 6 for data or pilot signal transmission. In a case where the channel width of the EHT MU PPDU is 320 MHz and an STA is using the third lowest 80 MHz channel as the operating channel, the control unit 202 controls the STA not to use the subcarrier positioned at the end of the RU3 of the 996-tone RU illustrated in FIG. 6 for data or pilot signal transmission. In a case where the channel width of the EHT MU PPDU is 320 MHz and an STA is using the highest 80 MHz channel as the operating channel, the control unit 202 controls the STA not to use the subcarrier positioned at the end of the RU4 of the 996-tone RU illustrated in FIG. 6 for data or pilot signal transmission.

Transmission to an STA operating with the 160 MHz channel width will be described below. In a case where the channel width of the EHT MU PPDU is 320 MHz and an STA is using 160 MHz on the low frequency side as the operating channel, the control unit 202 controls the STA not to use the subcarrier positioned at the end of the RU1 of the 2×996-tone RU illustrated in FIG. 6 for data or pilot signal transmission. In a case where the channel width of the EHT MU PPDU is 320 MHz and an STA is using 160 MHz on the high frequency side as the operating channel, the control unit 202 controls the STA not to use the subcarrier positioned at the end of the RU2 of the 2×996-tone RU for data or pilot signal transmission.

At each end of the operating channel, each of n+1 and m+1 equals the number of subcarriers not used for data or pilot signal transmission from among the subcarriers illustrated in FIG. 5 or 6. However, the numbers are not necessarily multiples of the number of subcarriers configuring RU. The total number of subcarriers at the ends can be smaller than the number of subcarriers configuring the 26-tone RU as the minimum unit of the RU.

In comparison with a case where a specific RU itself is not used as a blank area, the above-described configuration enables using many subcarriers for data transmission, thus preventing the degradation of the throughput of wireless communication.

The number of subcarriers not used for data or pilot signal transmission (i.e., the values of m and/or n) from among the subcarriers illustrated in FIG. 5 or 6 may be predetermined or determined through the negotiation between the AP 101 and the STAs. In the negotiation between the AP 101 and an STA, the number of unused subcarriers may be determined by using the Association Request/Response or the Probe Request/Response frame. The control unit 202 may notify of the number of unused subcarriers by using the QoS Data, the QoS Null, or the Class 3 Management frame used in the OMI procedure, and determine the number of unused subcarriers. In addition, other frames such as the Action frame may be used for the negotiation.

In a case where predetermined values are used without the negotiation between apparatuses regarding the value indicating the number of subcarriers not used for data or pilot signal transmission (in other words, the values of m and/or n), for example, the value of m can be set to 5 and the value of n to 5. The values of m and n may be set to values larger than the number of subcarriers configuring the 26-tone RU, which is the smallest RU. For example, the value of m can be set to 30 and the value of n to 30. In this case, the boundary between subcarriers not used for data or pilot signal transmission and subcarriers used therefor may coincide with none of the RU boundaries illustrated in FIG. 5 or 6. For example, in a case where the value of n is set to 30 in communication with the above-described STA 1, the boundary between subcarriers on the low frequency side of the operating channel is −1012+30, i.e., between −982 and −981. This subcarrier index does not coincide with −986 and −985, which is the boundary between the RU1 and RU2 of the 26-tone RU used in general communication illustrated in FIG. 5. The present exemplary embodiment makes it possible to finely determine whether to use a subcarrier for data or pilot signal transmission, using a subcarrier as the minimum unit. Therefore, the above-described configuration enables improving the data transmission efficiency in comparison with a case where the RU equivalent to the end of the operating channel of an STA is not assigned to the STA but only the RU close to the center of the operating channel of an STA is assigned to the STA. These values are to be considered as illustrative, and the present invention is not limited thereto. The above-described m and n are examples of predetermined numbers indicating the ends.

In the negotiation between apparatuses, these values may be set according to the scale or the processing speed of hardware resources used in the filtering processing on the STA. In this case, the larger the scale or the higher the processing speed, the smaller the setting value of m or n. On the other hand, the smaller the scale or the lower the processing speed, the larger the setting value of m or n.

The control unit 202 controls an STA with an operating channel width larger than the channel width of the EHT MU PPDU to fully use the ends of the subcarriers illustrated in FIG. 5 or 6 for data and pilot signal transmission.

Upon completion of data transmission in step S406 or S407, the processing returns to step S401. Then, the control unit 202 continues the operation for the transmission of the EHT MU PPDU.

In step S408, the control unit 202 determines whether to stop the provision of a wireless network based on an instruction input by the user. In a case where the control unit 202 determines to stop the provision of a wireless network (YES in step S408), the control unit 202 performs shutdown processing (not illustrated) and then ends the series of transmission processing. On the other hand, in a case where the control unit 202 does not determine to stop the provision of a wireless network (NO in step S408), the processing returns to step S401.

Examples of relevant instructions include an instruction by pressing a hardware key such as a power button or an instruction by pressing a shutdown button displayed on the touch panel.

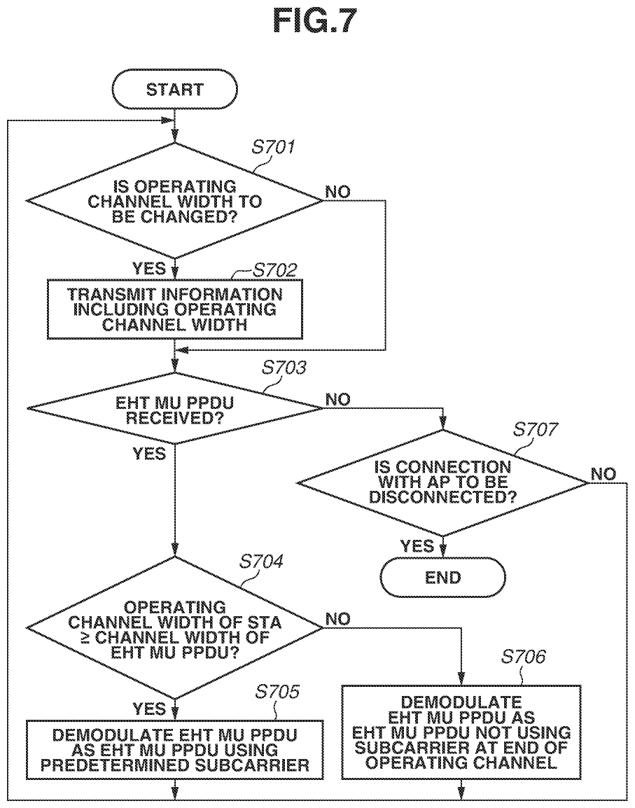

The operation of the STA 102 related to the reception of the EHT MU PPDU will be described below with reference to FIG. 7. The operations of the STAs 103 and 104 are similar to the operation of the STA 102. This operation is started when the STA 102 is connected with the AP 101 conforming to the IEEE 802.11be standard, i.e., when the STA 102 participates in the wireless network provided by the AP 101.

In the STA 102, each piece of the processing in FIG. 7 is implemented by the control unit 202 of the STA 102 hardware-wise and implemented by the frame processing unit 302 of the STA 102 functionality-wise. The following descriptions will be made on the premise that the operation is performed by the control unit 202.

Processing for participating in a wireless network will be described below. An STA such as the STA 102 participates in the wireless network provided by an AP such as the AP 101, based on an instruction input by the user. When the STA receives a Beacon frame transmitted by the AP 101 prior to participation, the STA 102 transmits an Association Request frame to the AP 101 to request for the participation in the wireless network. The STA 102 subsequently receives an Association Response frame as a response frame transmitted from the AP 101 and then participates in the wireless network provided by the AP 101.

The STA 102 transmits a Probe Request frame for finding an AP. Then, upon reception of a Probe Response frame as a response frame to the request, the STA 102 finds the AP 101 and then transmits the above-described request to the AP 101.

The Association Request and the Probe Request frames include information indicating the operating channel width of the STA 102. The information about the operating channel width is indicated by using each element illustrated in FIG. 8. For example, the information is indicated by the value of the Supported Channel Width Set subfield of the HE Capabilities element. Alternatively, the information is indicated by this value or the value of the Supported For 320 MHz In 6 GHz subfield of the EHT Capabilities element. The information about the operating channel width is indicated by a combination of the value of the Supported Channel Width Set subfield of the HT Capabilities or the VHT Capabilities element and the value of the extension field. In this case, the extension field used for the combination is the Extended NSS BW Support subfield.

In step S701, the control unit 202 determines whether to change the operating channel width of the STA 102. In a case where the control unit 202 determines to change the operating channel width of the STA 102 (YES in step S701), the processing proceeds to step S702. On the other hand, in a case where the control unit 202 does not determine to change the operating channel width of the STA 102 (NO in step S701), the processing proceeds to step S703. The operating channel width may be determined based on an instruction input by the user or determined by the STA 102 determining a channel width that minimizes the influence of peripheral electric wave noise.

In step S702, the control unit 202 transmits information including the operating channel width to the AP 101, and the processing proceeds to step S703. The information including the operating channel width is similar to the information illustrated in FIGS. 8 and 9, and redundant descriptions thereof will be omitted.

In step S703, the control unit 202 determines whether the EHT MU PPDU is newly received from the AP 101. In a case where the control unit 202 determines that the EHT MU PPDU is received (YES in step S703), the processing proceeds to step S704. On the other hand, in a case where the control unit 202 determines that the EHT MU PPDU is not received (NO in step S703), the processing proceeds to step S707.

In step S704, the control unit 202 determines whether the operating channel width of the STA 102 is equal to or larger than the channel width of the EHT MU PPDU. More specifically, the control unit 202 decodes the symbol corresponding to the U-SIG field, which is a part of the preamble of the EHT MU PPDU. Then, the control unit 202 refers to the value of the BW field obtained as a result of the decoding, and identifies the channel width of the EHT MU PPDU. In case where the control unit 202 determines that the operating channel width of the STA 102 is larger than the identified channel width (YES in step S704), the processing proceeds to step S705. On the other hand, in a case where the control unit 202 determines that the operating channel width of the STA 102 is not equal to or larger than the identified channel width (i.e., the operating channel width of the STA 102 is smaller than the identified channel width) (NO in step S704), the processing proceeds to step S706.

In step S705, the control unit 202 demodulates the received EHT MU PPDU as an EHT MU PPDU in which the predetermined subcarriers illustrated in FIG. 5 or 6 are used.

In step S706, the control unit 202 attempts to demodulate the EHT MU PPDU as an EHT MU PPDU in which the subcarrier at the end of the operating channel is not used for data or pilot signal transmission. More specifically, the control unit 202 reads the subcarrier index corresponding to the operating channel from a table 1 stored in the storage unit 201. Table 1 stored in the storage unit 201 indicates subcarrier indices to be used in a case where the operating channel width is smaller than the channel width of the EHT MU PPDU. The storage unit 201 also stores a table 2 storing subcarrier indices to be used in a case where the operating channel width is the channel width of the EHT MU PPDU. Table 2 stores combinations of RUs and subcarrier indices illustrated in FIGS. 5 and 6.

On the other hand, subcarrier indices in table 1 store the value obtained by subtracting “n” from one end of the subcarrier index of each RU in table 2, and the value by obtained by subtracting “m” from the other end thereof. Table 1 may be generated based on table 2 stored in the STA 102 at the time of factory shipment, or table 1 itself may be stored at the time of factory shipment. In the negotiation between the AP 101 and the STA 102 regarding the number of subcarriers not used for data or pilot signal transmission, the control unit 202 needs to be configured to generate table 1 based on n and m determined based on the negotiation between the apparatuses and on table 2.

In a case of receiving such a signal with a channel width larger than the operating channel width, an effect of attenuating signals outside the operating channel can be obtained by the filtering processing at the time of signal reception. This filtering processing attenuates signals outside the operating channel from the received signal by using a frequency filter to extract the signal in the operating channel. Then, the control unit 202 generates a signal sampled at a sampling frequency equal to the operating channel width and then demodulates the signal. Simply performing the above-described filtering processing and sampling processing may cause aliasing at subcarrier portions including the ends.

On the other hand, according to the present exemplary embodiment, the demodulation target subcarrier is determined based on table 1, and hence the subcarrier at one end of the actual operating channel and the subcarrier at the other end thereof are excluded from the demodulation target subcarrier. This processing enables the STA 102 to demodulate only the signal carried by the subcarrier both ends of which in the operating channel of the STA 102 are excluded from the demodulation target subcarrier, as a significant signal.

In this case, a signal superimposed on the subcarrier at the end of the operating channel of the STA 102, signals outside the operating channel of the STA 102 or carried by subcarriers of other than the RU assigned to the STA 102. This enables suitably demodulating the data destined to the communication apparatus and carried by subcarriers other than the ends of subcarriers from among a plurality of subcarriers configuring RUs assigned to the communication apparatus.

Finally, upon completion of the receive processing in step S705 or S706, the processing returns to step S701. Then, the control unit 202 continues the operation for receiving the EHT MU PPDU.

In step S707, the control unit 202 determines whether to disconnect the connection with the AP 101 based on an instruction input by the user. In a case where the control unit 202 determines to disconnect the connection (YES in step S707), the control unit 202 disconnects the connection with the AP 101 and then ends the operation for receiving the EHT MU PPDU. On the other hand, in a case where the control unit 202 does not determine to disconnect the connection with the AP 101 (NO in step S707), the processing returns to step S701. Then, the control unit 202 continues the operation for receiving the EHT MU PPDU. Examples of instructions for the disconnection include a shutdown instruction, an instruction by pressing a button for disconnecting the connection with a wireless network, an instruction by pressing a button for turning OFF the wireless function, and an instruction by pressing a button for turning the in-apparatus mode ON.

The above-described series of transmission and reception processing enables data transmission without using the subcarrier corresponding to the end of the operating channel when receiving a signal with a channel width larger than the operating channel width. Therefore, as a result of the filtering processing and sampling processing, in a case where a large influence of aliasing noise due to signals carried by neighboring channels is expected, it is possible to perform data exchange without using the subcarrier at the end where a high error rate is assumed at the time of demodulation.

### OTHER EMBODIMENTS

Various embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-143291, filed Sep. 8, 2022, which is hereby incorporated by reference herein in its entirety.

What is claimed is:

1. A communication system comprising:
at least a first communication apparatus; and
a second communication apparatus,
wherein the first communication apparatus comprises:
at least one memory that stores a set of instructions; and
at least one processing circuit,
wherein the first communication apparatus is caused, by the at least one processing circuit executing the instructions and/or the at least one processing circuit itself operating, to perform operations comprising:
receiving, from the second communication apparatus, information indicating a bandwidth to be used by the second communication apparatus to communicate with the first communication apparatus;
transmitting, in transmitting a downlink Multi-User Physical Layer Protocol Data Unit (MU PPDU) to a plurality of communication apparatuses including at least the second communication apparatus with a predetermined bandwidth in a case where the bandwidth to be used by the second communication apparatus indicated by the received information is smaller than the predetermined bandwidth, an MU PPDU in which a subcarrier at the end of a frequency domain is not modulated with demodulation target data but a subcarrier different from the subcarrier at the end is modulated with demodulation target data, from among subcarriers that are to store data to be transmitted to the second communication apparatus,
wherein the second communication apparatus comprises:
at least one memory that stores a set of instructions; and
at least one processing circuit,
wherein the second communication apparatus is caused, by the at least one processing circuit executing the instructions and/or the at least one processing circuit itself operating, to perform operations comprising:
demodulating, in a case where the MU PPDU with the predetermined bandwidth larger than the bandwidth to be used is received, the MU PPDU, assuming that the data that is modulating a subcarrier configuring the frequency domain different from the subcarrier at the end, is demodulation target data.

2. A communication apparatus comprising:
at least one memory that stores a set of instructions; and
at least one processing circuit,
wherein the communication apparatus is caused, by the at least one processing circuit executing the instructions and/or the at least one processing circuit itself operating, to perform operations comprising:
receiving, from another communication apparatus, information indicating a bandwidth to be used by the other communication apparatus to communicate with the communication apparatus; and
transmitting, in transmitting a downlink MU PPDU to a plurality of other communication apparatuses including at least the other communication apparatus with a predetermined bandwidth in a case where the bandwidth to be used by the other communication apparatus indicated by the received information is smaller than the predetermined bandwidth, an MU PPDU in which a subcarrier at the end of the frequency domain is not modulated with demodulation target data but a subcarrier different from the subcarrier at the end is modulated with demodulation target data, from among subcarriers in the frequency domain that are to store data to be transmitted to the other communication apparatus.

3. A communication apparatus comprising:
at least one memory that stores a set of instructions; and
at least one processing circuit,
wherein the communication apparatus is caused, by the at least one processing circuit executing the instructions and/or the at least one processing circuit itself operating, to perform operations comprising:
transmitting, to another communication apparatus, information indicating a bandwidth to be used by the communication apparatus to communicate with the other communication apparatus; and
demodulating, in a case where a downlink MU PPDU with a predetermined bandwidth larger than the bandwidth is received, data destined to the communication apparatus, assuming that data modulating the subcarrier configuring the frequency domain and different from the subcarrier corresponding to the end of the frequency domain, is decoding target data, the frequency domain being one of a plurality of frequency domains to which data destined to the communication apparatus is assigned.

4. The communication apparatus according to claim 3, wherein the number of subcarriers corresponding to the end is smaller than the number of subcarriers configuring a minimum unit of a Resource Unit (RU) in the Institute of Electrical and Electronic Engineers (IEEE) 802.11 standard.

5. The communication apparatus according to claim 3, wherein the information indicating the bandwidth to be used is stored in a Supported Channel Width Set subfield of a HE Capabilities element and communicated between apparatuses.

6. The communication apparatus according to claim 3, wherein the information indicating the bandwidth to be used is stored in a Channel Width subfield of an OM Control subfield and communicated between apparatuses.

7. The communication apparatus according to claim 3, wherein a bandwidth of the MU PPDU is identified based on information stored in a BW field of a Universal Signal (U-SIG) field configuring a preamble of the MU PPDU.

8. The communication apparatus according to claim 2,
wherein subcarriers in the frequency domain are subcarriers excluding a null subcarrier in the frequency domain, and
wherein, in transmitting the downlink MU PPDU in a case where the bandwidth to be used by the other communication apparatus is smaller than the predetermined bandwidth, the communication apparatus transmits an MU PPDU in which the predetermined number of subcarriers configuring the end of the frequency domain are not modulated with decoding target data, from among subcarriers in the frequency domain that are to store data to be transmitted to the other communication apparatus.

9. The communication apparatus according to claim 1, wherein the first and the second communication apparatuses are capable of performing wireless communication conforming to the IEEE 802.11be standard.

10. The communication system according to claim 2, wherein the communication apparatus is capable of performing wireless communication conforming to the IEEE 802.11be standard.

11. The communication system according to claim 3, wherein the communication apparatus is capable of performing wireless communication conforming to the IEEE 802.11be standard.

12. A method for communication apparatus, the method comprising:
receiving, from another communication apparatus information indicating a bandwidth to be used by the other communication apparatus to communicate with the communication apparatus; and
transmitting, in transmitting a downlink MU PPDU to a plurality of other communication apparatuses including at least the other communication apparatus with a predetermined bandwidth in a case where the bandwidth to be used by the other communication apparatus indicated by the received information is smaller than the predetermined bandwidth, an MU PPDU in which a subcarrier at the end of the frequency domain is not modulated with demodulation target data but a subcarrier different from the subcarrier at the end is modulated with demodulation target data, from among subcarriers in the frequency domain to be subjected to storage of data to be transmitted to the other communication apparatus.

13. A method for communication apparatus, the method comprising:
transmitting information indicating a bandwidth to be used by the communication apparatus to communicate with the other communication apparatus, to the other communication apparatus; and
demodulating, in a case where a downlink MU PPDU with a predetermined bandwidth larger than the bandwidth is received, data destined to the communication apparatus, assuming that data modulating the subcarrier configuring the frequency domain that is different from the subcarrier corresponding to the end of the frequency domain, is decoding target data, the frequency domain being one of a plurality of frequency domains to which data destined to the communication apparatus is assigned.
